(19) United States
(12) Patent Application Publication
(10) Pub. No.: US 2023/0351537 A1
(43) Pub. Date: Nov. 2, 2023

(54) GLOBAL EMERGENCY ROADSIDE ASSISTANCE SYSTEM

(71) Applicant: Bihama Vedaste, San Jose, CA (US)

(72) Inventor: Bihama Vedaste, San Jose, CA (US)

(21) Appl. No.: 17/733,525

(22) Filed: Apr. 29, 2022

(51) Int. Cl. G06Q 50/26; G06Q 30/06

(52) U.S. Cl. CPC G06Q 50/265; G06Q 30/0611

(57) ABSTRACT

A system for universal repair referral and history is provided comprising a server and an application executing on the server. The system receives a message from a motorist device requesting roadside automotive service and determines a geographic location of motorist device. The system also sends descriptions of providers of requested roadside service to the motorist device, the providers proximate the geographic location. The system also sends cost of requested roadside service quoted by each provider. The system also dispatches to the geographic location, based on a selection received from the motorist device, a first provider of the providers. The providers are previously qualified by the system to provide the requested roadside service proximate the geographic location.

### CROSS REFERENCE TO RELATED APPLICATIONS

None

### FIELD OF THE DISCLOSURE

The present disclosure is in the field of motorist services. More particularly, the present disclosure provides systems and methods of providing motorists who are enrolled in a program provided herein and are stranded and in need of roadside assistance to be given a list of nearby service providers and their proposed costs of service, the motorists further given the option to select the service provider of their choice and make payment through the system.

### BACKGROUND

Roadside assistance has evolved slowly over time with stranded motorists originally receiving aid from other helpful motorists. Public phones brought about the ability to call a tow truck or mechanic to get assistance though infrastructure was still poor. Challenges have persisted as locating stranded motorists in roadside locations was difficult and dangerous. Global positioning systems (GPS) became prevalent and disabled vehicles could be located more readily or could share their locations.

Insurers and service providers eventually became aware of the problem and began to initiate membership programs offering roadside assistance. A motorist subscribing to such a roadside membership program may call a number. The program may have a call center locate the motorist and then recommend a service provider proximate the motorist. However, the nearby service provider in many cases must be accredited by the program.

Some programs allow a stranded motorist to self-locate using an application or app on a mobile and arrange for help via the app. In case of an accident, a motorist can take and upload pictures using the app. Roadside assistance has come a long way. But programs and insurers often overpay for services because they do not know the value of the subject vehicle as it is difficult to remotely determine the condition of the vehicle.

### BRIEF DESCRIPTION OF THE FIGURES

FIG. 1 is a block diagram of a system of global emergency roadside assistance according to an embodiment of the present disclosure.

FIG. 2 is a block diagram of a system of global emergency roadside assistance according to an embodiment of the present disclosure.

### DETAILED DESCRIPTION

Systems and methods described herein select location-based automotive service providers to assist stranded motorists who have subscribed to a program provided by the system and have requested assistance under the program. The system determines location of the stranded motorist and matches the motorist with nearby service providers who have been vetted and deemed qualified to provide the type of service the motorist needs. The system determines from each candidate service provider in the vicinity of the stranded motorist what each provider will charge for parts and services needed by the stranded motorist.

The system communicates cost of parts and service proposed by each service provider to the stranded motorist. Based on the motorist's selection, the system dispatches the selected service provider and handles the motorist's payment, if any, such that the motorist need not transact with the provider at the roadside location and can instead be on his/her way without further delay.

The system allows motorists to compare prices for parts and services offered by area providers and allows motorists to choose their preferred provider based on the motorist's own situation. The system qualifies providers, thus the motorist is not restricted to providers that might be limited by an insurance-based program or a motorist-assistance program. The system may allow insurance providers to broaden their coverage as the system guarantees the service of its providers on the platform.

The system further allows providers of roadside automotive services and other services to fairly compete as their prices may be visible among themselves. The program also includes databases of vendors of new and used auto parts from which a motorist may purchase direct if circumstances permit.

While the scenario and embodiments described above are concerned with motorists of disabled vehicles that are stranded at a roadside location, systems and methods provided herein are also appropriate for non-emergency situations wherein a motorist may, for example, be shopping for automotive services or parts from home. A vehicle owner may shop from home and make selections from listings of local service providers that are offered by the system.

The system further allows a user to receive automatic updates on vehicle manufacturer recalls. Vehicle information will be known by the system whether the user has changed his/her personal information or not.

Accident reporting is made easier, faster, and mandatory as most providers of these services will have to be contacted via the app. Even if the user doesn't use the app, the provider will report accidents in their database which will be linked to the system via APIs.

The system also makes it easier to request emergency medical service. When the system detects blasts or forceful behavior, the system via the motorist device may automatically dial emergency services, such as a 911-type of number used in the United States. If the location does not have such emergency services, the system connects to local emergency providers like hospital or clinic that have registered with the system.

Roadside assistance is localized currently. If a driver is covered by an AAA program, the driver may not be covered by the other insurance. An expanded version of this problem is that if a user ships a vehicle out of the US, the vehicle is not covered or the mechanic in the foreign country will not know the history of the car. Worse yet, many countries have no roadside assistance.

All the information gathered allows the system to create a graph or history of the vehicle. The history will consist of repairs, maintenance services, accidents, and change of ownership records. This may be beneficial to not just individuals but also organizations such as insurance providers, law enforcement agencies, vehicle dealerships, car rating firms, manufacturers, and spare parts vendors, and towing and hauling companies.

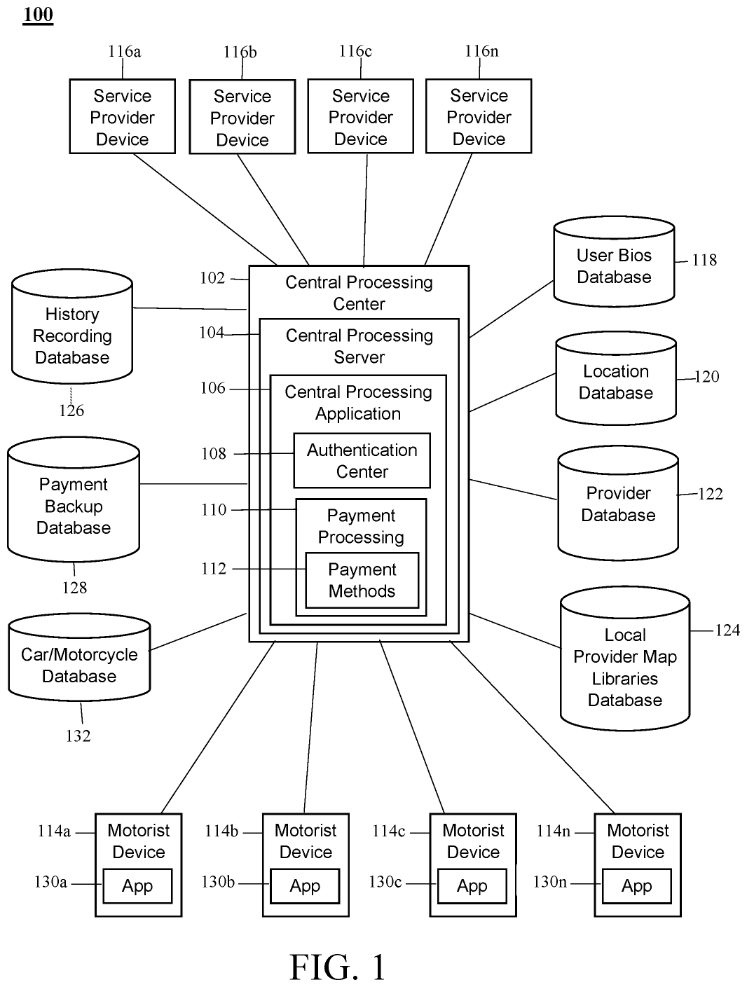

Turning to the figures, FIG. 1 depicts components and interactions of a system 100 of global emergency roadside assistance. The system 100 comprises a central processing center 102, a central processing server 104, and a central processing application 106. For brevity purposes, the central processing center 102, the central processing server 104, and the central processing application 106 may be referred to as the center 102, the server 104, and the application 106, respectively.

The system 100 also comprises an authentication center 108, payment processing component 110, and payment methods 112. The system 100 also comprises motorist devices 114a-n and service provider devices 116a-n which may be referred to for brevity purposes as provider devices 116a-n.

The system also comprises a user bios database 118, a location database 120, and a provider database 122. The system also comprises a local provider map libraries database 124, a history recording database 126, a payment backup database 128, and a motorist app 130a-n.

The central processing center 102 is at least one physical location that houses a plurality of data processing and other devices that support systems and methods provided herein. In an embodiment, the center 102 is a location for the components provided herein except for the motorist devices 114a-n and service provider devices 116a-n.

The server 104 is at least one computer located at least partially at the center 102. In embodiments, the server 104 comprises multiple physical devices located at multiple physical geographic sites.

The application 106 executes on the server and provides much of the functionality of systems and methods provided herein. The application 106 may comprise a plurality of software modules executing on a plurality of physical hardware components comprising the server 104.

Motorist devices 114a-n may be mobile devices carried by customers of programs based on the system 100 provided herein. Motorist devices 114a-n host at the least one motorist app 130a-n, referred to as app 130a-n for brevity, that communicates with the application 106. The use of the component name “motorist devices” is not meant to imply that this component is used primarily or even at all by drivers or other users of motor vehicles. The motorist devices 114a-n may be used in non-automotive applications, for example when a user is at home and seeks to communicate with the center 102 for matters unrelated to vehicle use.

When a customer enrolls in a program that is based on systems and methods provided herein, the customer downloads the app 130 to their motorist device 114a-n from the server 104. The customer provides the following information:
1. User biodata or personal information that is stored in the user bios database 118.
2. User car, bicycle, or motorcycle details stored in the car/motorcycle database 132.
3. User or provider location at the time of registration.

The information above is linked the user payments methods 112 component and the local provider map libraries database 124. Payments are stored in the payment backup database 128.

When a user of the motorist device 114a-n requests service, the request is received by the server 104. The request is tested against information the server 104 has stored, through user information in the user bios database 118, through information in the car/motorcycle database 132, and against address information of the user.

Once the customer is verified, the customer's request is sent to the local provider map libraries database 124. This database contains records that describe roads and providers in the area of the motorist device 114a-n or navigation data related to the platform.

Once the request is referenced with contents of the location database 120, the closest and most affordable provider is located. The customer chooses the provider, and they are matched. The user and the provider are shown the maps and driving directions depending on who requested the service or what type of the service is to be provided. If roadside service is to be provided, then the provider will be shown the fastest way to get to the user. If the customer wants to visit the provider, the app 130 will show the customer the best route to the provider.

The app 130 displays to the customer the cost of the requested service before either of the user or provider is dispatched. Once the requested service is provided and complete, both the user and provider conclude the trip and rate or comment on each other. Only trip referencing codes are shown with how much user spent or the provider made.

On a back end of the app 130, a trip record is stored, and a ledger of all services is made. Material may also be stored in the history recording database 126.

Requests made via the app 130 are added to the vehicle's history in the car/motorcycle database 132. Users of motorist devices 114a-n, provider, and others may access and review the life history of vehicles in the program. Previous implementations such as Kelly Blue Book may only access information from law enforcement or insurance records. There is no self-reporting or repair history available previous to systems and methods provided herein. This information may be valuable to parties who sell, buy or insure cars and desire assurance that they are actually getting the maximum benefit.

Features of systems and methods provided herein are at least as follows:
1. Universal automotive life and repair history
2. Universal automotive repair referral service
3. Automated user generated repair service requests
4. Universal automated location based roadside emergency requests
5. Automated repair provider/user search and interactions based on specific geographical location
6. Universal roadside incident coverage
7. Universal automotive identification registration and tracker
8. Universal automotive history lookup
9. Automated recall or vehicle issues distribution from maker to user
10. Universal emergency vehicle automated geo-locator
11. Universal mechanics and service offered database
12. Customized automotive parts search
13. Universal roadside medical emergency
14. Universal automated fuel on demand service
15. Universal automotive records sharing using a single chain
16. Universal automated voice search and request of mechanic, fuel, or emergency roadside service
17. Universal automated car search and rescue (last transmission or when stolen)
18. Universal automated car history update (if it is sold, or registered in another country)
19. Universal auto incident reporting

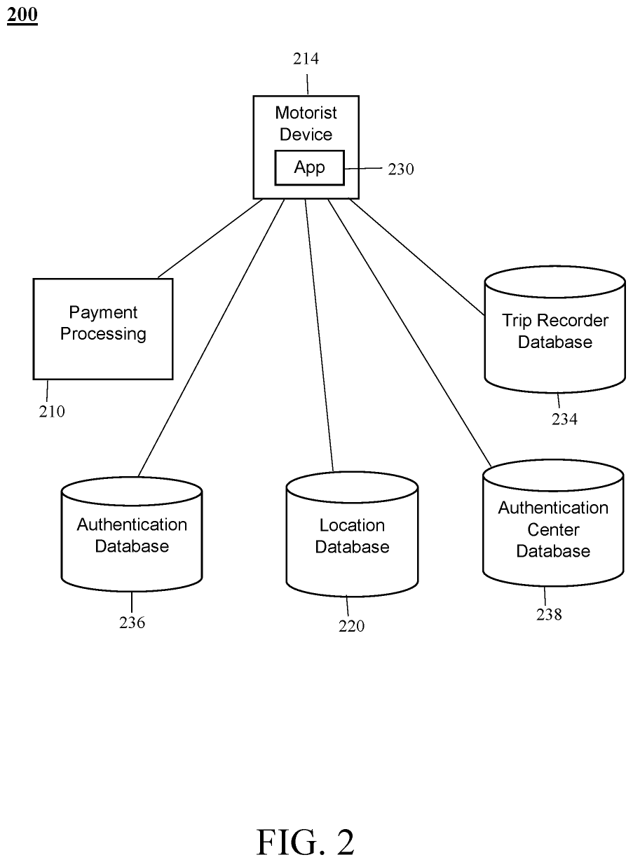

FIG. 2 illustrates components and interactions of a system 200 of global emergency roadside assistance. FIG. 2 is directed to how an individual user is onboarded to the system 200 and accesses services provided thereunder. Components of the system 200 are indexed to components of the system 100.

A user of the motorist device 214 downloads the app 230 and follows a set-up process. In the setup, the user is asked to provide full name, address, vehicle identification number, and their preferred method of service. The system sends the user an email to confirm the submitted information. An Internet link is also provided that leads to further verification.

When a service provider is registering for the program the provider must provide a government-issued business license and a certificate of their relevant skills issued by relevant domains, such as university or college certificate of training. The information is stored in an authentication center database 238.

When a user of the motorist device 214 needs services such as emergency roadside assistance, normal repair, purchase of a spare part, or purchase of fuel, the user logs into the app 230 executing on the motorist device 214.

The user navigates into a services section of the app 230 and selects the needed service. The app 230 authenticates the user via stored credentials and determines the location of the motorist device 214. The app 230 uses location of the motorist device 214 to search for the closest, fastest, and cheapest service provider from a group of service providers within a certain radius around the motorist device 214. Map data and provider information are stored in the location database 220.

When the app 230 is finished searching for providers, the app 230 displays the providers found by order of proximity and pricing of their services. Once the user has chosen a provider, the user is then matched with the provider. The system confirms prices, and the trip is recorded. The system verifies that the user has sufficient funds in their forms of payment provided in the app 230 during set up and the fees are temporarily sent to their financial institution. The steps described above may be backed up and encrypted using military grade encryption.

If the user wants a roadside service performed on his/her vehicle or wants a part or gas delivered, the system 200 illustrates the trip progression on the motorist device 214 using maps displayed by the app 230. If the user is traveling to the provider, the app 230 provides to the motorist device 214 how to reach the provider's location with map information and estimated time of arrival. Information about trip is saved by the system.

In an embodiment, a system for universal repair referral and history is provided comprising a server and an application executing on the server. The system receives a message from a motorist device requesting roadside automotive service and determines a geographic location of motorist device. The system also sends descriptions of providers of requested roadside service to the motorist device, the providers proximate the geographic location. The system also sends cost of requested roadside service quoted by each provider. The system also dispatches to the geographic location, based on a selection received from the motorist device, a first provider of the providers. The providers are previously qualified by the system to provide the requested roadside service proximate the geographic location. The motorist device additionally selects needed parts associated with the requested roadside service from a plurality of previously determined suppliers. The system processes payment for roadside service. The system, prior to the motorist device requesting service, stores information describing a vehicle associated with the motorist device. The requested roadside service is for the vehicle. The motorist device requests the service via an application executing on the motorist device.

In another embodiment a method for providing roadside assistance is provided. The method comprises a mobile device requesting a roadside service for a vehicle. The method also comprises the device receiving a description of providers of the requested roadside service, the providers proximate a geographic location of the device. The method also comprises the device receiving a cost of the requested service quoted by each of the described providers. The method also comprises the device sending a selection of a first provider of the described providers. The method also comprises the device transmitting approval of payment for the requested service to the first provider. The method also comprises the device executing a locally stored application to request the service. The method also comprises the device communicating with a remotely located central processing center to request the service. The method also comprises the device capturing images of damage to the vehicle incurred in a collision. The method also comprises the device transmitting the images with the request for service. The method also comprises the device, prior to requesting the service, downloading an application facilitating submission of requests for roadside service. The method also comprises the device, via the downloaded application, furnishing information about the vehicle and an operator of the vehicle to the central processing center.

In yet another embodiment, a system for promoting vehicle operator safety is provided comprising a mobile device and an application stored and executing on the mobile device that detects occurrence of a violent physical event immediately proximate the device. The system also initiates, based on the detection and without user input, electronic contact with a publicly provided emergency service proximate the device. The system also transmits location of the device to the emergency service and transmits to the emergency service at least one of audible, visual, and textual material describing the event. The violent physical event is at least one of a collision of a vehicle associated with the mobile device, an injury suffered by a user of the mobile device, and a criminal act suffered by a user of the mobile device. The system, upon detecting that the publicly provided emergency service is not available, contacts a proximate hospital. The mobile device is registered with a subscription service that stores information describing a vehicle associated with the mobile device and further stores information describing at least one user of the mobile device. Information about collisions experienced by vehicles associated with the mobile device is stored by a central storage facility. The information is made available to law enforcement agencies.

What is claimed is:

1. A system for universal repair referral and history, comprising:
a server; and
an application executing on the server that:
receives a message from a motorist device requesting roadside automotive service,
determines a geographic location of motorist device,
sends descriptions of providers of requested roadside service to the motorist device, the providers proximate the geographic location,
sends cost of requested roadside service quoted by each provider, and
dispatches to the geographic location, based on a selection received from the motorist device, a first provider of the providers.

2. The system of claim 1, wherein the providers are previously qualified by the system to provide the requested roadside service proximate the geographic location.

3. The system of claim 1, wherein the motorist device additionally selects needed parts associated with the requested roadside service from a plurality of previously determined suppliers.

4. The system of claim 1, wherein the system processes payment for roadside service.

5. The system of claim 1, wherein the system, prior to the motorist device requesting service, stores information describing a vehicle associated with the motorist device.

6. The system of claim 5, wherein the requested roadside service is for the vehicle.

7. The system of claim 1, wherein the motorist device requests the service via an application executing on the motorist device.

8. A method for providing roadside assistance, comprising:
a mobile device requesting a roadside service for a vehicle;
the device receiving a description of providers of the requested roadside service, the providers proximate a geographic location of the device;
the device receiving a cost of the requested service quoted by each of the described providers;
the device sending a selection of a first provider of the described providers; and
the device transmitting approval of payment for the requested service to the first provider.

9. The method of claim 8, further comprising the device executing a locally stored application to request the service.

10. The method of claim 8, further comprising the device communicating with a remotely located central processing center to request the service.

11. The method of claim 8, further comprising the device capturing images of damage to the vehicle incurred in a collision.

12. The method of claim 11, further comprising the device transmitting the images with the request for service.

13. The method of claim 9, further comprising the device, prior to requesting the service, downloading an application facilitating submission of requests for roadside service.

14. The method of claim 13, further comprising the device, via the downloaded application, furnishing information about the vehicle and an operator of the vehicle to the central processing center.

15. A system for promoting vehicle operator safety, comprising:
a mobile device
an application stored and executing on the mobile device that:
detects occurrence of a violent physical event immediately proximate the device;
initiates, based on the detection and without user input, electronic contact with a publicly provided emergency service proximate the device;
transmits location of the device to the emergency service; and
transmits to the emergency service at least one of audible, visual, and textual material describing the event.

16. The system of claim 15, wherein the violent physical event is at least one of a collision of a vehicle associated with the mobile device, an injury suffered by a user of the mobile device, and a criminal act suffered by a user of the mobile device

17. The system of claim 15, wherein the system, upon detecting that the publicly provided emergency service is not available, contacts a proximate hospital.

18. The system of claim 15, wherein the mobile device is registered with a subscription service that stores information describing a vehicle associated with the mobile device and further stores information describing at least one user of the mobile device.

19. The system of claim 15, wherein information about collisions experienced by vehicles associated with the mobile device is stored by a central storage facility.

20. The system of claim 19, wherein the information is made available to law enforcement agencies.
